(19) United States
(12) Patent Application Publication
(10) Pub. No.: US 2009/0307027 A1
(43) Pub. Date: Dec. 10, 2009

(54) Repair order management

(75) Inventors: Robert L. Charbeneau, San Antonio, TX (US); Craig M. Finnigan, Spring, TX (US)

Correspondence Address: Jo Katherine D'Ambrosio;D'Ambrosio & Associates, P.L.L.C., Suite 465, 10260 Westheimer Road, Houston, TX, 77042, US

(73) Assignee: CAR Research, Inc., Houston, TX (US)

(21) Appl. No.: 12/157,226

(22) Filed: Jun. 9, 2008

(51) Int. Cl. G06Q 10/00; G06Q 30/00

(52) U.S. Cl. 705/7; 705/1

(57) ABSTRACT

Systems and methods used by automobile service centers to manage repair orders are disclosed. The repair order management system retrieves information pertaining to the processing of the repair orders from one or more service center databases. The retrieved information is processed by the system to generate one-line summaries for each repair order. The one-line repair order summaries are displayed on one or more screens of a secure web-based user interface. The displayed one-line repair order summaries are automatically updated to reflect updates to the repair orders. The one-line repair order summaries allow service personnel at the automobile service center to quickly obtain concise information on each repair order and thereby, expedite processing of repair orders.

### FIELD OF THE INVENTION

This invention relates to systems and methods for managing data. More specifically, the invention relates to managing repair orders at automobile service centers.

### BACKGROUND OF THE INVENTION

Automobile service centers generate repair orders to keep track of service requests. The information in the repair order is stored in one or more automobile dealer or automobile service center databases. Each repair order contains detailed information on completing the repair order, including service requested, customer name, automobile make, etc. This detailed information is usually presented in multiple line paragraphs. Since service centers invariably deal with a number of service requests on a daily basis, a correspondingly large number of repair orders are also generated.

### SUMMARY OF THE INVENTION

Customers have a number of options when choosing where to obtain preventative maintenance or repair services for their automobiles. They range from the service centers attached to automobile dealerships, full-service repair and maintenance franchises and the local (mom-and-pop) service centers. Even with this competition, good customer service can lead to customer loyalty and increased sales. An important aspect of good customer service is to ensure that service requests are completed quickly and within the timeframe promised to the customer.

In order to ensure that the large numbers of everyday service requests are effectively and timely processed, it is important for each service technician to quickly obtain a summary of all service or repair orders assigned to them. They also need means to quickly determine parts, if any, recommended to complete a service request and more importantly, if the parts are available in inventory. The service center management also needs a quick means to assess the status of all open repair orders, how productive any given service technician is, and to manage the workflow assigned to the service technicians. The service center management also needs a real-time daily aggregate or summary of gross receipts, including a breakdown of services covered under warranty and services paid for by the customer.

Service centers, in order to increase their profit margins, also offer customers other premium and value-added services in the course of completing the service requests. These services can range from brake replacement, changing air filters and replacing tires. Therefore, the service technicians must also have easy access to the other value-added services recommended for a given automobile.

The systems and methods of the present invention facilitate improved customer relationship management by providing automobile service center personnel with one-line summaries of pertinent information for each repair order. The repair order management system retrieves information pertaining to the processing of the repair orders from two or more service center databases or database systems. The retrieved information is processed by the system to generate one-line summaries of each repair order. The one-line repair order summaries are displayed on one or more screens or web pages of a secure web-based user interface. The displayed one-line repair order summaries are automatically updated using information retrieval computer code to reflect new or updates to the repair order information stored in the service center databases. The one-line repair order summaries allow service personnel at the automobile service center to quickly obtain concise information on each repair order and thereby, expedite processing of repair orders.

In one embodiment, the invention comprises computer program product for an automobile service center. The computer program product comprises a computer usable medium having computer usable or readable program code embodied within. The computer usable code is configured to automatically retrieve information pertaining to one or more automobile repair orders. The repair order information is retrieved from one or more automobile service center databases and/or automobile dealership databases. The computer program product further comprises computer usable code configured to process the retrieved repair order information to generate one-line summaries of each repair order. The computer program product comprises computer usable code that is configured to provide a secure web-based user interface. The web-based user interface comprises at least one screen for displaying the one-line repair order summaries. Computer usable code is configured to automatically update the displayed one-line repair order summaries.

In another embodiment, the repair order management system comprises a communication network. Two or more service center databases are operatively connected to the communication network. The service center databases store information pertaining to one or more repair orders. The repair order management system further comprises one or more computer processors. The computer processors execute software code or one or more stored sequences of instructions to automatically retrieve information on the one or more repair orders stored in the one or more service center databases. The information is processed to generate one-line summaries for each repair order. The one-line repair order summaries are updated to reflect inbound and outbound telephone calls to and from the service center over a computer-telephone integrated (CTI) platform. Authorized users are alerted by automated flagging of the one-line repair order summaries when required parts or other services for the automobile are needed. The one-line repair order summaries are automatically updated by retrieving information on available parts. The information on the available parts is stored in the one or more service center databases. The one-line repair order summaries are updated with information on the available parts. The one-line repair order summaries are automatically refreshed by continuously accessing the repair orders from the database servers. The executed instructions are stored within a memory. The repair order management system further comprises one or more display terminals operatively connected to the network. The display terminals provide authorized users with access to the one-line repair order summaries.

In another embodiment, authorized users access the repair order management information from a web-based user interface. The web-based user interface comprises at least one screen for displaying one-line repair order summaries. The web-based user interface further comprises one or more display regions. A first display region is configured to display the one or more one-line repair order summaries. A second display region is configured to display aggregate repair order information comprising total number of repair orders, total number of repair orders in progress and total number of overdue repair orders. A third display region is configured to display other customizable information comprising total number of customers served and service center gross revenues or receipts. A fourth display region is configured to display repair order search criteria. The search criteria comprise repair order number, tag number and customer name. Access to the web-based user interface is secured and restricted to authorized users at the service center.

### BRIEF DESCRIPTION OF THE DRAWINGS

FIG. 1 is a block diagram of a networked system according to one embodiment.

FIG. 2 is a flow chart according to one embodiment.

FIG. 3 is a flow chart according to another embodiment.

FIG. 4 is a display according to one embodiment.

### DETAILED DESCRIPTION

Service center personnel handle large numbers of service requests on a daily basis. In order to process these service request quickly and efficiently, they need quick access to information pertaining to the repair orders. This information needs to be presented in a concise format in order to process the large numbers of repair orders, track the status of assigned repair orders or to quickly respond to customer inquiries.

The present invention teaches methods and systems for managing automobile service requests. Embodiments of the present repair order management system allow service center personnel to achieve greater productivity per repair order and deliver better customer service by presenting summarized information on all active repair orders. The repair order management system also tracks in real-time, daily aggregate revenues from premium services and gross receipts.

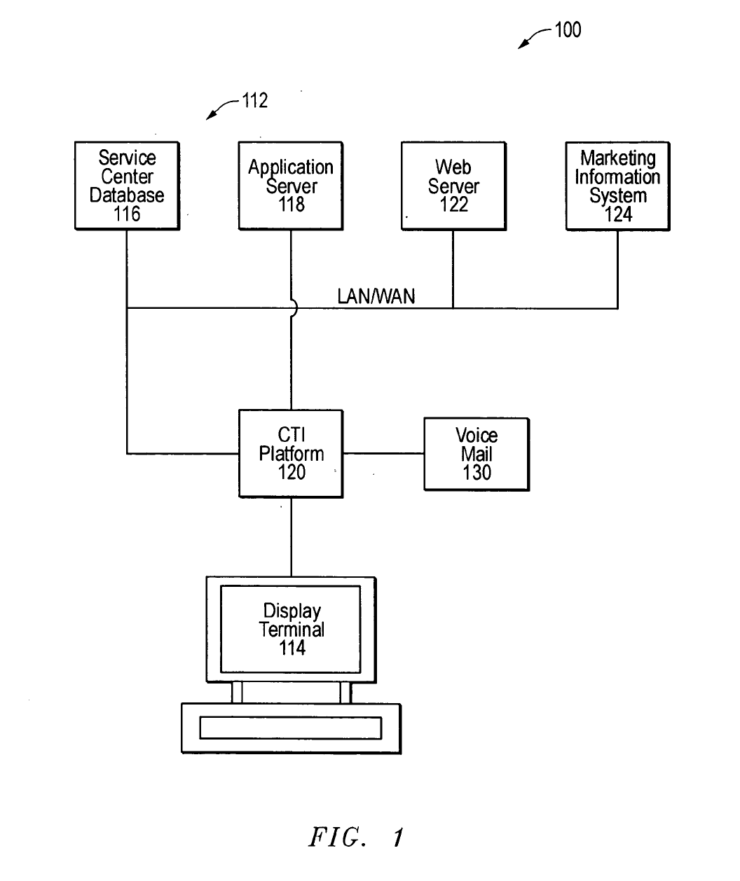

FIG. 1 is a block diagram of a repair order management system 100 that includes a server sub-system 112, sometimes referred to herein as server 112, and one or more display terminals 114 connected to server 112. Computerized programs and instructions are stored in server 112 and can be accessed by a user at any one of display terminals 114. In one embodiment, display terminals 114 are computers including a web browser, and server 112 is accessible to display terminals 114 via a network such as an intranet or a wide area network such as the Internet. In an alternative embodiment, display terminals 114 could be any client system capable of interconnecting to the intranet or the Internet including a web based digital assistant, a web-based phone or other web-based connectable equipment. In another embodiment, server 112 is configured to accept information over a computer-telephone integrated (CTI) platform 120.

Display terminals 114 are interconnected to the network, such as a local area network (LAN) or a wide area network (WAN), through many interfaces including dial-in-connections, cable modems and wireless connections. Server 112 includes one or more service center databases 116 connected to an application server 118 and a web server 122. In one embodiment, the web server 122 is stored on application server 118 and is accessed by potential customers at a display terminal 114 by logging onto server sub-system 112. In an alternative embodiment, the web server 122 is stored remotely from the application server 118. In another embodiment, an external marketing information system or marketing database 124 is connected to server 112. In one embodiment, application server 118 contains the computer program code for analyzing and processing repair order information stored in the service center database 116.

The service center databases 116 contain information on all aspects of a customer's relationship with the service center. The information comprises customer name, address and contact information, the make, model and year of the automobile or vehicle; whether the automobile is owned or leased by the customer, mileage information, prior service history including date of last service and previous services requested. The service center databases 116 also store operational information pertaining to finance, accounting, sales, payroll, parts and supplier records. The service center databases 116 also store information pertaining to repair orders. Service center personnel enter information pertaining to the repair orders in the service center databases 116. Repair orders are typically assigned to one or more service technicians for completion. Each repair order contains detailed information including service(s) requested, customer name, automobile make, etc. on completing the repair order. The detailed information can run into multiple line paragraphs for each repair order. A service center, specially a large automotive repair center, may generate several repair orders daily. The repair order management system 100 condenses the detailed information for each repair order into one-line summaries of the data.

User profiles are maintained in the server 112 for each authorized user. Each user profile includes a user name and password for each user. A user accesses the repair order management system 100 through a web-based user interface accessible through the display terminals 114 using his/her respective user name and password.

The web-based user interface is a graphical user interface accessible only to authorized users. The system 100 can be secured using combination of encryption, authentication, and authorization technologies. Encryption is a means of sending information between participants in a manner that prevents other parties from reading the information. Authentication is a process of verifying a party's identity. Authorization is a technique for determining what actions a participant is allowed to perform.

The system 100 can authenticate the user using a number of different approaches, from simple password or challenge response mechanisms. Other authentication mechanisms known in the art such as smart cards and biometric devices such as fingerprint readers can also be used.

Service center management can develop authorization policies that can restrict access to the web pages and database tables or files. Authorization may be granted by user names, or roles containing users. Users can either be internal or external to a system. Users are authorized to access information in order to perform their job functions. Such access may be controlled so that a user gets access only to the information needed to perform his job function. Alias users may also be supported. An alias of a user is another user who, under certain conditions, inherits all the access of the user. For instance, an alias of a user can be created to perform his job function while he is absent.

Through the secure repair order management web page, authorized users may login to the system 100, display summarized information on repair orders and query the repair order management system 100 through a browser application run by a computer 114, such as a desktop or laptop personal computer. The repair order management web page may reside in the application server 118 or a web server 122. The system 100 is set up such that the server 112 may communicate information to and acquire information from a plurality of users through the display terminals 114 simultaneously.

In one embodiment, authorized service technicians after logging in to the system have access only to the repair orders assigned to them. In another embodiment, managers and other designated personnel, have access to all repair orders in the system. This role-based access allows the service technicians to focus on the repair orders assigned to them while allowing the service center management to keep track of all impending and overdue repair orders, thus giving them access to information that allows them to quickly reassign repair orders to other service technicians, if necessary.

The repair order management system 100 is additionally configured to track inbound and outbound telephone calls over a CTI platform 120. The CTI platform 120 represents any of a number of systems that enable a computer-based device to operate like a call center to accept and route incoming calls to a designated service technician. In an exemplary embodiment, the CTI platform 120 may be configured to handle incoming and outgoing phone calls to the service center. The CTI platform 120 may have certain computer-executable instructions capable of permitting the CTI platform 120 to interface with a voice mail system 130, so as to convert voice messages left for a particular customer to other audio file formats for transmission to the other network addresses (e.g., an email address). The information from the CTI platform is stored in the server 112. This information is processed and summarized totals on number of calls to/from customers are displayed on the web-based user interface. 114 This information allows service center management to measure service technician responsiveness and ensure better customer service. As shown in FIG. 1, it is well known to those skilled in the art that the connection between the users and system 100 includes a firewall and other hardware and software security measures to ensure that unauthorized users do not gain access to system 100.

In one embodiment, the display terminal 114 is a Personal Computer (PC) loaded with an Internet browser. In alternative embodiments, the user can access the repair order management system 100 through the Internet using any Internet ready device such as a web enabled Personal Digital Assistant (PDA), a cell phone or an interactive TV.

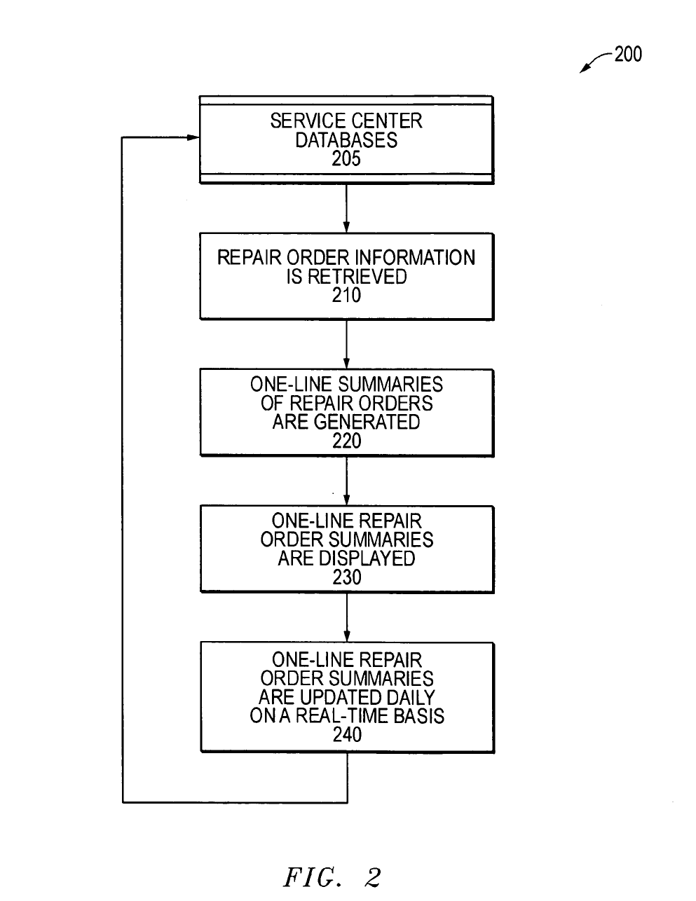

FIG. 2 depicts an embodiment of the computer implemented method of the repair order management system 200. Information pertaining to one or more automobile repair orders is automatically retrieved from one or more service center databases 210. The retrieved repair order information is processed to generate one or more one-line summaries for each repair order 220. A secure web-based user interface is provided to for displaying the one-line repair order summaries 230. The one-line repair order summaries are automatically updated to reflect new, changes or updates to the repair order information by continuously retrieving using information retrieval code, in real-time, updated information on the repair orders from the service center databases 240.

Information pertaining to the one or more repair orders is stored in the service center databases 205. This information comprises records of every customer's prior history with the respect to the service center, including information on customer name, automobile service request history, automobile make, automobile model, automobile model year, mileage information, ownership or lease records, prior services requested, current repair order status and warranty information. In addition to customer information, the service center databases 205 also comprise information on sale or lease records, accounting information, financing, parts and services for repairs, payroll and employee information.

The repair order management system 200 retrieves the repair order information 210 and using customizable logic, summarizes information from each repair order within a single line 220. The one-line repair order summary allows service center personnel to quickly assess the status of any given repair order. Each repair order summary can be customized based on user requirements. In one embodiment, the one-line repair order summary 220 comprises information on customer name, service technician name, repair order number, tag number (a number generated by a particular user using their business rules; tag numbers can vehicle information numbers (VIN) or can be any number designated by the user), automobile mileage, repair order status, automobile make, automobile model and expected completion schedule for the repair order.

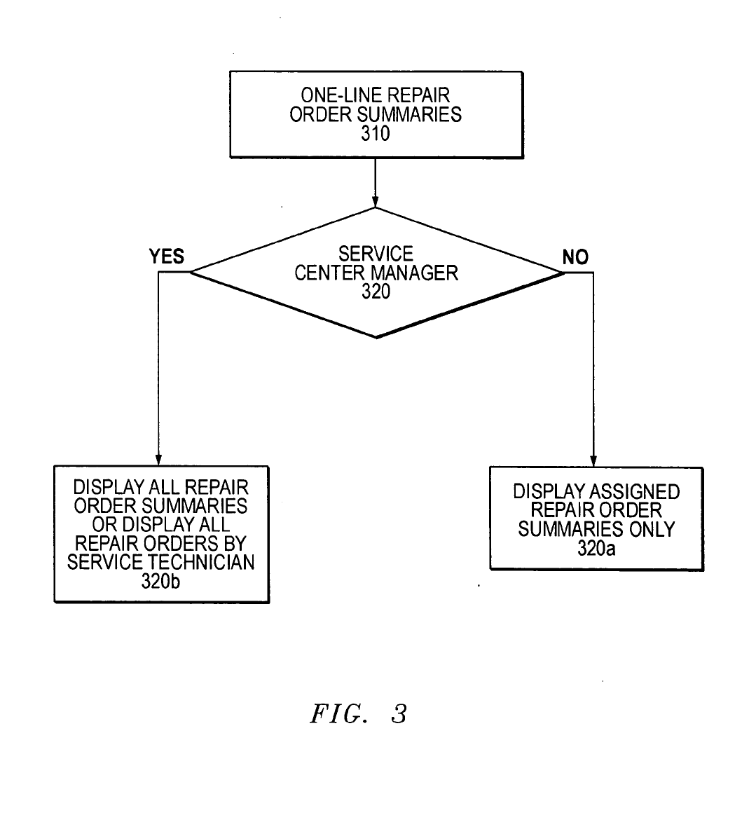

In another embodiment, shown in FIG. 3, the one-line summaries 310 can be grouped together based on the service technician assigned to the repair order 320a. This allows the service technician to obtain a quick overview of all repair orders assigned to him/her.

Service center management, on the other hand, can access summaries of all repair orders 320b or summaries of repair orders assigned to any service technician at the service center. This gives busy service center management a quick “global” overview of the workflow and allows them to track employee productivity. In one embodiment, the one-line repair order summaries that have impending or missed repair order deadlines are automatically flagged. Various color codes, for example, can also be used to denote repair orders not started, repair orders that are currently being worked on or pre-assigned, repair orders completed or repair orders that are on hold. Service center management can use this information to reassign work among the service technicians to meet deadlines and, in general, ensure improved customer satisfaction by completing repair orders on a timely basis.

In one embodiment, the one-line repair order summaries further comprise information on recommended premium services for the automobile. The premium services are so-called because the service centers typically charge a premium for these services. Therefore, it is important for the service centers to “sell” as much premium services, as possible. However, service center personnel are also constrained by time and to maximize revenues, it is important to for them to quickly determine which premium services were purchased in the past by the customer.

In an embodiment of the invention, shown in FIG. 1, the information on the premium services is stored either in the service center databases 116 or marketing information systems 124. This information is retrieved by pre-programmed instructions stored in the application server 118 and the one-line repair order summaries are customized and updated to include information on premium services recommended for the given automobile. In one embodiment, service center management can customize the repair order management system 100 to track the desired premium services. The one-line repair order summaries also include information on prior services purchased by the customer. This information can be used to tailor customer-specific marketing initiatives. For example, customers can receive mail or email notifications on up-coming required maintenances.

In order to complete processing a service request, it may sometimes be necessary to replace automobile parts. Information on parts needed for a given automobile is stored in the service center databases 116. It is also important for the service center personnel to determine if the required parts are actually available in inventory, either at the service center or at an affiliated parts center, and also if the parts are covered under a previously purchased warranty. Parts information, including their availability in inventory and coverage under warranty, is retrieved from either a service center database 116 or from an external parts system database. The retrieved information, along with associated warranty information, is then used to update the one-line repair order summaries.

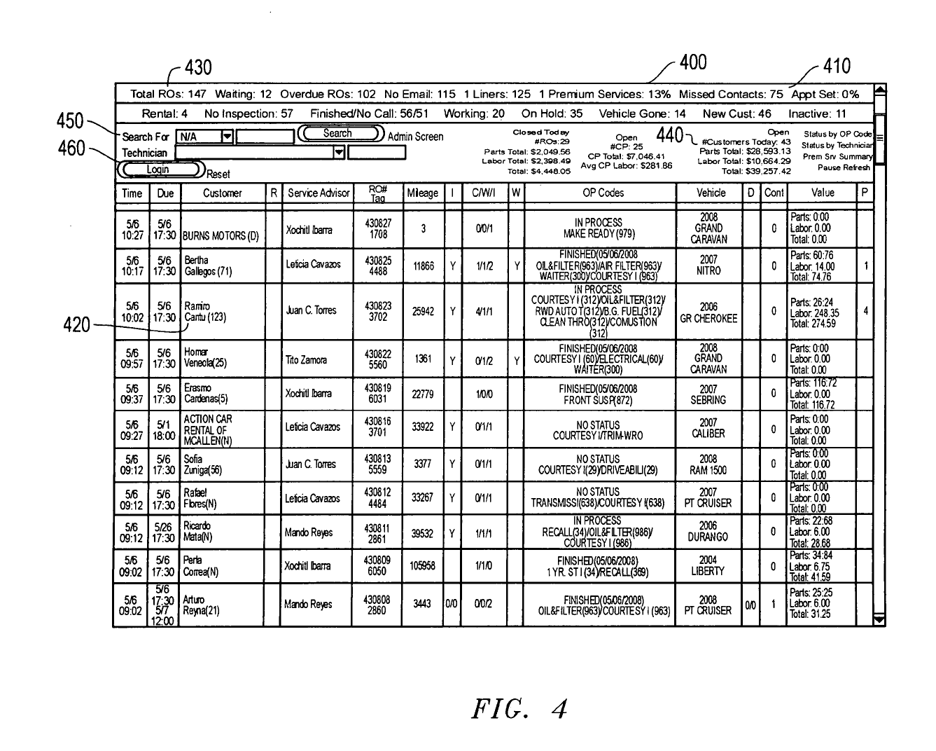

In one embodiment, shown in FIG. 4, the one-line repair order summaries created by the repair order management system 400 are displayed on a web-based user interface 410. The web-based user interface is a graphical user interface 410. The web-based user interface 410 comprises one or more screens or web pages 410. In one embodiment, each web page 410 comprises one or more display regions configured to display information on a daily, real-time basis. A display region 420 is configured to display the one or more one-line repair order summaries. One or more display regions 430 are configured to display aggregate information on the repair orders. In one embodiment, this second display region 420, display aggregate or summary information on total number of repair orders, total number of repair orders currently being worked on or in progress and total number of repair orders that are overdue or that has a deadline that has passed. In other embodiments, the total number of rental automobiles, the number of new customers and number of emails sent to customers can be tracked in the second display region 430.

One or more display regions 440 are configured to display customizable aggregate information. In one embodiment, the third display region 440 displays on a real-time basis daily aggregate or summary information on total number of customers served and gross revenues or receipts. In other aspects, the third display region 440 can track total number of closed repair orders and total parts and labor charges.

In another embodiment, a display region is further configured to display repair order search criteria 450. This fourth display region 450 allows for repair orders to be searched by repair order number, tag number and customer name.

Users can login to the repair order management system 460 through the user interface 410. Service technicians can enter their name and password to obtain a summarized list of all repair orders assigned to them. They can also search for repair orders by repair order number, tag number or customer name. Service center management and other designated users can login to the system to obtain a list comprising one-line summary of all repair orders 420 or repair orders assigned to select service technicians.

A first display region 420 comprises one or more one-line repair order summaries. The one-line repair order summaries comprise information needed to complete the repair request. This can include the date the repair order was opened, the promised completion date and time, customer name, whether the automobile is a rental, color coded operational codes to indicate status of the repair order, services offered to the customer and services declined by the customer, total parts and labor charges for each repair order and total number of premium services requested per repair order. Fields like customer name can be hyperlinked to additional information on the customer such as complete customer history, customer contact information, whether the customer is a new or returning customer and prior services requested.

The above-described embodiments can be implemented as computer program product. This embodiment may comprise a series of computer instructions or computer code either fixed on a tangible medium, such as a computer usable or readable media, for example, a diskette, a CD-ROM, a ROM memory, or a fixed disk, or transmittable to a computer system, via a modem or other interface device over a medium. The medium either can be a tangible medium, including but not limited to optical or analog communications lines, or may be implemented with wireless techniques, including but not limited to microwave, infrared or other transmission techniques. It may also be the Internet. The series of computer instructions embodies all or part of the functionality previously described herein with respect to the invention. Those skilled in the art will appreciate that such computer instructions can be written in a number of programming languages for use with many computer architectures or operating systems. Further, such instructions may be stored using any memory technology, present or future, including, but not limited to, semiconductor, magnetic, optical or other memory devices, or transmitted using any communications technology, present or future, including but not limited to optical, infrared, microwave, or other transmission technologies. It is contemplated that such a computer program product may be distributed as a removable media with accompanying printed or electronic documentation, e.g., shrink wrapped software, pre-loaded with a computer system, e.g., on system ROM or fixed disk, or distributed from a server or electronic bulletin board over a network, e.g., the Internet or World Wide Web.

The systems, methods, programs, and processes described in relation to the present invention are not limited to any particular computer system and may take the form of a hand-held digital computer, a personal computer, a workstation, a server, a mainframe computer, and a supercomputer.

The repair order management system provides concise, real-time, on-line information that allows the service center personnel to proactively obtain a clearer picture of the performance of service technicians, enabling better preparation for any arising problems or delays in processing repair orders. It also allows service center personnel to take advantage of potential up-selling opportunities that may arise.

The flowcharts and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially, concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for the purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A computer implemented method for managing automobile repair orders at a service center, the method comprising:
automatically retrieving information pertaining to one or more automobile repair orders from two or more service center databases, wherein each repair order concerns a service request for the automobile;
processing the retrieved repair order information to generate one-line summaries for each repair order;
providing a web-based user interface for displaying the one-line repair order summaries; and
automatically updating the one-line repair order summaries using information retrieval computer code, wherein the one-line repair order summaries are updated by retrieving on a real-time basis the repair order information from the service center database.

2. The computer implemented method of claim 1, wherein the repair order information further comprises information on customer name, automobile service request history, automobile make, automobile model, automobile model year, mileage information, ownership or lease records, repair order status and warranty information.

3. The computer implemented method of claim 1, wherein the one-line repair order summaries further comprise user customizable information.

4. The computer implemented method of claim 1, wherein access to the web-based user interface is restricted to authorized users at the service center.

5. The computer implemented method of claim 4, further comprising role-based user access to the displayed one-line repair order summaries.

6. The computer implemented method of claim 1, further comprising computer generated flagging the one-line repair order summaries having impending or missed repair order deadlines.

7. The computer implemented method of claim 6 further comprising updating the one-line repair order summaries with recommended premium services associated with the automobile, the recommended premium services retrieved from a marketing information system.

8. The computer implemented method of claim 6 comprising alerting the user on parts or other services required for the automobile.

9. The computer implemented method of claim 1 further comprising retrieving information from the one or more service center databases on parts availability.

10. A computer program product for an automobile service center, the computer program product comprising:
a computer usable medium having computer usable program code embodied therewith, the computer usable code comprising:
computer usable code configured to automatically retrieve information pertaining to one or more automobile repair orders, wherein the repair order information is retrieved from one or more service center databases;
computer usable code configured to process the retrieved repair orders to generate one-line summaries for each repair order;
computer usable code configured to provide a graphical user interface, wherein the graphical user interface is web-based having at least one screen for displaying the one-line repair order summaries;
computer usable code configured to automatically update the displayed one-line repair order summaries based on new or changes to the repair order information entered into the service center databases.

11. The computer program product of claim 10, wherein the one-line repair order summary comprises information on customer name, service advisor name, repair order number, tag number, automobile mileage, repair order status, automobile make, automobile model and expected completion schedule for the repair order.

12. The computer program product of claim 10, wherein the one-line repair order summary further comprises information on the parts recommended for processing each repair order.

13. The computer program product of claim 12, wherein the one-line repair order summary further comprises information on whether the recommended parts are covered under warranty.

14. The computer program product of claim 10, wherein the graphical user interface comprises one or more display regions.

15. The computer program product of claim 14, wherein a display region is configured to display the one or more one-line repair order summaries.

16. The computer program product of claim 14, wherein a display region is configured to display daily real-time information comprising total number of repair orders, total number of repair orders in progress and total number of overdue repair orders.

17. The computer program product of claim 14, wherein a display region is configured to display daily real-time information comprising total number of customers served and service center gross receipts.

18. The computer program product of claim 14, wherein a display region is configured to display repair order search criteria.

19. The computer program product of claim 18, wherein the search criteria comprises repair order number, tag number and customer name.

20. The computer program product of claim 10 additionally configured to track inbound and outbound telephone calls over a computer-telephone integrated (CTI) platform.

21. The computer program product of claim 10 further comprising a computer readable medium wherein the computer usable code is stored on the computer readable medium.

22. A repair order management system comprising:
a communication network;
one or more service center databases operatively connected to the communication network, the service center databases retrievably storing information pertaining to one or more repair orders;
one or more computer processors;
one or more stored sequences of instructions which, when executed by the one or more processors, cause the one or more processors to carry out the instructions for:
automatically retrieving information on the one or more repair orders from the one or more service center databases, wherein each repair order concerns a service request for the automobile;
processing the retrieved repair orders to generate one-line summaries for each repair order;
updating the one-line repair order summaries by monitoring inbound and outbound telephone calls over a CTI platform;
alerting an authorized user by flagging the one-line repair order summaries for required parts or other services for the automobile;
updating the one-line repair order summaries by retrieving information on available parts, the information on the available parts stored in the one or more service center databases;
amending the one-line repair order summaries with the information on the available parts; and
automatically refreshing the one-line repair order summaries by continuously accessing the repair orders from the database servers;
a memory for storing the executed instructions; and
a plurality of display terminals operatively connected to the network, each of the display terminals providing the authorized user with access to the one-line repair order summaries.

23. The repair order management system of claim 22 further comprising instructions for automatically identifying recommendations for premium services associated with the automobile.

24. The repair order management system of claim 22 integrated with one or more marketing information systems to develop customer-specific marketing initiatives.

25. A web-based user interface for managing automobile repair orders, the web-based user interface comprising:
at least one screen for displaying one-line repair order summaries;
the web-based user interface further comprising one or more display regions wherein:
a first display region is configured to display the one or more one-line repair order summaries;
a second display region is configured to display information comprising total number of repair orders, total number of repair orders in progress and total number of overdue repair orders;
a third display region is configured to display information comprising total number of customers served and service center gross receipts;
a fourth display region is configured to display repair order search criteria, wherein the search criteria comprises repair order number, tag number and customer name;
wherein access to the web-based user interface is restricted to authorized users at the service center.
